(19) United States
(12) Patent Application Publication
(10) Pub. No.: US 2012/0002022 A1
(43) Pub. Date: Jan. 5, 2012

(54) IMAGE CODING APPARATUS, IMAGE CODING METHOD, PROGRAM, AND INTEGRATED CIRCUIT

(76) Inventors: Hideyuki Ohgose, Osaka (JP); Katsuki Urano, Nara (JP); Kiyofumi Abe, Osaka (JP); Hiroshi Arakawa, Nara (JP); Yuki Maruyama, Osaka (JP); Yuki Kobayashi, Osaka (JP)

(21) Appl. No.: 13/175,348

(22) Filed: Jul. 1, 2011

(30) Foreign Application Priority Data
Jul. 2, 2010 (JP) 2010-152527
Jun. 30, 2011 (JP) 2011-146803

(51) Int. Cl. H04N 13/00

(52) U.S. Cl. 348/51; 348/E13.06

(57) ABSTRACT

An image coding apparatus records stereoscopic video partially as 2D video so as to enable display to be performed while seamlessly switching between 3D video and 2D video, and includes: a control unit that sets one of a 2D coding mode and a 3D coding mode which are modes of coding the stereoscopic video so that, when displayed in 3D, the stereoscopic video is displayed as 2D video and 3D video respectively; and a coding unit that, in the case where the control unit switches from the 3D coding mode to the 2D coding mode, codes the to stereoscopic video according to a 3D coding standard in the 3D coding mode, and codes the stereoscopic video according to the 3D coding standard using a coding condition in the 2D coding mode, the coding condition being a condition for causing the stereoscopic video to be viewed as the 2D video when displayed.

### BACKGROUND OF THE INVENTION

(1) Field of the Invention

The present invention relates to an image coding apparatus and an image coding method, and in particular relates to an image coding apparatus and an image coding method that code three-dimensional (3D) video stereoscopically perceived by a viewer.

(2) Description of the Related Art

Multiview Video Coding (MVC) is a standard developed as an extension of H.264. MVC is employed as a method of recording 3D video on Blu-ray Discs and displaying the 3D video, and its application to a format of capturing and recording 3D video by camcorders and the like is currently under study.

It is considered that viewing 3D video tends to cause more eye fatigue than viewing normal two-dimensional (2D) video. Especially in the case where a displayed object has a large amount of left-right disparity, a pop-out effect increases, which tends to cause eye fatigue. Eye fatigue also tends to be caused in the case where the object has large motion.

In view of these problems, techniques of changing 3D video which tends to cause eye fatigue to 2D video are disclosed. For example, Japanese Unexamined Patent Application Publication No. 3-286693 (hereafter, Patent Literature 1) discloses a stereoscopic television apparatus that detects motion of a subject, displays a right-eye image and a left-eye image alternately during normal time, and displays only one of the right-eye image and the left-eye image in the case where large motion is detected. Japanese Unexamined Patent Application Publication No. 11-355808 (hereafter, Patent Literature 2) discloses a video system that detects an amount of disparity, evaluates its impact on a viewer, and switches between 3D video and 2D video based on an evaluation result.

Moreover, as a method of recording 3D video as 2D video, Japanese Patent No. 4183587 (hereafter, Patent Literature 3) discloses an image recording apparatus that stores 3D video and 2D video as separate files, or extracts one of a right-eye image and a left-eye image in 3D video and records the extracted image as 2D video in a normal 2D video format.

### SUMMARY OF THE INVENTION

However, the above conventional techniques have the following problems.

The techniques described in Patent Literatures 1 and 2 are techniques of switching between 3D video and 2D video when displaying video, and cannot switch between 3D video and 2D video and perform coding when recording video. For example in the case of coding 3D video and streaming the coded 3D video, it is desirable to switch between 3D video and 2D video at the time of coding so as to prevent eye fatigue, rather than switching between 3D video and 2D video on the display side.

The technique described in Patent Literature 3 stores 3D video and 2D video in separate files, which makes it difficult to perform display while seamlessly switching between 3D video and 2D video.

The present invention is made in view of the above circumstances, and has an object of providing an image coding apparatus and an image coding method that can record stereoscopic video partially as 2D video so as to enable display to be performed while seamlessly switching between 3D video and 2D video.

To solve the stated problems, an image coding apparatus according to one aspect of the present invention is an image coding apparatus that codes stereoscopic video, the image coding apparatus including: a control unit that sets a coding mode to one of a 2D coding mode and a 3D coding mode, the 2D coding mode being a mode of coding the stereoscopic video so that, when the coded stereoscopic video is decoded and displayed in 3D, the stereoscopic video is displayed as 2D video, and the 3D coding mode being a mode of coding the stereoscopic video so that, when the coded stereoscopic video is decoded and displayed in 3D, the stereoscopic video is displayed as 3D video; and a coding unit that, in the case where the control unit switches the coding mode from the 3D coding mode to the 2D coding mode, codes the stereoscopic video according to a 3D coding standard when the coding mode is the 3D coding mode, and codes the stereoscopic video according to the 3D coding standard using a coding condition when the coding mode is the 2D coding mode, the coding condition being a condition for causing the stereoscopic video to be viewed as the 2D video when displayed.

According to this structure, the stereoscopic video can be recorded partially as 2D video so as to enable display to be performed while seamlessly switching between 3D video and 2D video.

Moreover, the control unit sets the coding mode, based on an image feature value relating to viewer fatigue when the coded stereoscopic video is decoded and displayed in 3D.

According to this structure, the coding mode is set based on the image feature value relating to the degree of viewer fatigue. Hence, a scene that tends to cause viewer fatigue in the stereoscopic video can be recorded as 2D video.

Moreover, the control unit includes: a detection unit that detects the image feature value, based on pixel data included in the stereoscopic video; and a condition determination unit that sets the coding mode based on the image feature value detected by the detection unit, and determines the coding condition in the case of setting the coding mode to the 2D coding mode.

According to this structure, it is possible to automatically switch the coding mode based on the image feature value of the stereoscopic video and determine the coding condition.

Moreover, the detection unit detects, as the image feature value, a disparity between two images that are paired when the stereoscopic video is displayed in 3D. Here, for example, the condition determination unit may set the coding mode to the 2D coding mode in the case where the amount of disparity is larger than a predetermined threshold.

According to this structure, the 2D coding mode is set based on the amount of disparity, with it being possible to ease viewer strain caused by viewing video having a disparity. In detail, in the case where the amount of disparity is larger than the threshold, the degree of fatigue of the viewer's eyes when viewing the stereoscopic video as 3D video increases. The image coding apparatus according to one aspect of the present invention codes the stereoscopic video as 2D video in such a case, thereby easing viewer strain caused by viewing video having a disparity.

Moreover, the detection unit detects, as the image feature value, an amount of motion in a time axis direction of at least one of two images that are paired when the stereoscopic video is displayed in 3D. Here, for example, the condition determination unit may set the coding mode to the 2D coding mode in the case where the amount of motion is larger than a predetermined threshold.

According to this structure, the 2D coding mode is set based on the amount of motion in the time axis direction, with it being possible to ease viewer strain caused by viewing video having motion in the time axis direction. In detail, in the case where the amount of motion in the time axis direction is larger than the threshold, the degree of fatigue of the viewer's eyes when viewing the stereoscopic video as 3D video increases. The image coding apparatus according to one aspect of the present invention codes the stereoscopic video as 2D video in such a case, thereby easing viewer strain caused by viewing video having motion in the time axis direction.

Moreover, the detection unit detects, as the image feature value, a quantization parameter applied to at least one of two images that are paired when the stereoscopic video is displayed in 3D. Here, for example, the condition determination unit may set the coding mode to the 2D coding mode in the case where the quantization parameter is larger than a predetermined threshold.

According to this structure, the 2D coding mode is set based on the quantization parameter, with it being possible to ease viewer strain caused by viewing video involving quantization. In detail, in the case where the quantization parameter is larger than the threshold, 3D video is coarse, and so the degree of fatigue of the viewer's eyes when viewing the stereoscopic video as 3D video increases. The image coding apparatus according to one aspect of the present invention codes the stereoscopic video as 2D video in such a case, thereby easing viewer strain caused by viewing video involving quantization.

Moreover, the condition determination unit determines the coding condition that one of two images that are paired when the stereoscopic video is displayed in 3D is replaced with an other one of the two images, and the coding unit replaces the one of the two images with the other one of the two images according to the coding condition, and codes two images resulting from the replacement according to the 3D coding standard.

According to this structure, the two images which are to be coded according to the 3D coding standard are made identical to each other. This ensures that the viewer views the stereoscopic video as 2D video. Besides, no special processing is required for the coding according to the 3D coding standard, which contributes to a reduced burden of the coding process.

Moreover, one of two images that are paired when the stereoscopic video is displayed in 3D includes a first viewpoint image of a first viewpoint, and an other one of the two images includes a second viewpoint image of a second viewpoint different from the first viewpoint, and the condition determination unit determines the coding condition so that the first viewpoint image and the second viewpoint image are coded as images closer to be identical to each other in the case of setting the coding mode to the 2D coding mode, than in the case of setting the coding mode to the 3D coding mode.

According to this structure, the first viewpoint image and the second viewpoint image are coded as images closer to be identical to each other in the case of setting the coding mode to the 2D coding mode, than in the case of setting the coding mode to the 3D coding mode. This allows the viewer to appropriately view the stereoscopic video as 2D video.

Moreover, in the case of setting the coding mode to the 2D coding mode, the condition determination unit: sets the first viewpoint image in a predetermined reference index in a first reference list; and determines the coding condition that a reference image is only the first viewpoint image set in the reference index, a motion vector is 0, and a residual is 0, as a coding condition of a macroblock included in the second viewpoint image.

According to this structure, the first viewpoint image and the second viewpoint image can be coded so as to be identical to each other by using disparity compensation. That is, the first viewpoint image and the second viewpoint image can be coded so as to be identical to each other according to H.264 MVC.

Moreover, in the case of setting the coding mode to the 2D coding mode, the condition determination unit: sets the first viewpoint image in a reference index 0 in a first reference list; and, in the case where a picture type of the second viewpoint image is a P picture, determines the coding condition that a coding type is a skip macroblock, as a coding condition of all macroblocks included in the second viewpoint image.

According to this structure, the first viewpoint image and the second viewpoint image can be coded so as to be close to be identical to each other, merely by coding information that all macroblocks included in the second viewpoint image are skip macroblocks. This enhances coding efficiency.

Moreover, in the case of setting the coding mode to the 2D coding mode, the condition determination unit: sets the first viewpoint image in a reference index 0 in a first reference list; and, in the case where a picture type of the second viewpoint image is a B picture, determines the coding condition that a reference image is only the first viewpoint image set in the reference index 0, a motion vector is 0, and a residual is 0 as a coding condition of a first macroblock, and also determines the coding condition that a coding type is a skip macroblock as a coding condition of a second macroblock, the first macroblock being a macroblock for which neighboring macroblock information is unusable among a plurality of macroblocks included in the second viewpoint image, and the second macroblock being a macroblock other than the first macroblock among the plurality of macroblocks included in the second viewpoint image.

According to this structure, the first viewpoint image and the second viewpoint image can be coded so as to be close to be identical to each other, merely by coding information that most macroblocks included in the second viewpoint image are skip macroblocks. This enhances coding efficiency.

Moreover, in the case of setting the coding mode to the 2D coding mode, the condition determination unit: sets the first viewpoint image in a reference index 0 in a first reference list and in a reference index 0 in a second reference list; and, in the case where a picture type of the second viewpoint image is a B picture, determines the coding condition that a coding type is a skip macroblock, as a coding condition of all macroblocks included in the second viewpoint image.

According to this structure, the first viewpoint image and the second viewpoint image can be coded so as to be close to be identical to each other, merely by coding information that all macroblocks included in the second viewpoint image are skip macroblocks. This enhances coding efficiency.

Moreover, in the case of setting the coding mode to the 2D coding mode, the condition determination unit: sets the first viewpoint image in a reference index 0 in a first reference list; and, in the case where a picture type of the second viewpoint image is a B picture, determines the coding condition that a picture type is a P picture and a coding type is a skip macroblock, as a coding condition of all macroblocks included in the second viewpoint image.

According to this structure, the first viewpoint image and the second viewpoint image can be coded so as to be close to be identical to each other, merely by coding information that all macroblocks included in the second viewpoint image are skip macroblocks. This enhances coding efficiency.

Note that the present invention may be realized not only as the image coding apparatus, but also as a method including steps corresponding to the processing units included in the image coding apparatus, or a program causing a computer to execute these steps. The present invention may also be realized as a computer-readable recording medium such as a CD-ROM (Compact Disc-Read Only Memory) in which the program is recorded, or information, data, or a signal representing the program. The program, the information, the data, and the signal may be distributed via a communication network such as the Internet.

Furthermore, the components that constitute the image coding apparatus described above may be partly or wholly implemented on one system LSI (Large Scale Integration). The system LSI is an ultra-multifunctional LSI produced by integrating a plurality of components on one chip, and is actually a computer system that includes a microprocessor, a ROM, a RAM (Random Access Memory), and the like.

The image coding apparatus and the image coding method according to the present invention can record stereoscopic video partially as 2D video so as to enable display to be performed while seamlessly switching between 3D video and 2D video.

### FURTHER INFORMATION ABOUT TECHNICAL BACKGROUND TO THIS APPLICATION

The disclosure of Japanese Patent Application No. 2010-152527 filed on Jul. 2, 2010 including specification, drawings and claims, and the disclosure of Japanese Patent Application No. 2011-146803 filed on Jun. 30, 2011 including specification, drawings and claims, are incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram explaining motion compensation and disparity compensation in H.264 MVC;

FIG. 2A is a block diagram showing an example of a structure of an image coding apparatus according to an embodiment of the present invention;

FIG. 2B is a block diagram showing an example of a structure of a coding unit according to Embodiment 1 of the present invention;

FIG. 3 is a diagram showing an example of an amount of disparity;

FIG. 4 is a flowchart showing an example of an operation of the image coding apparatus according to the embodiment of the present invention;

FIG. 5 is a flowchart showing an example of a coding condition setting process according to Embodiment 1 of the present invention;

FIG. 6 is a diagram showing an example of a relation between a coding target image and a reference image according to Embodiment 1 of the present invention;

FIG. 7A is a block diagram showing another example of the structure of the coding unit according to Embodiment 1 of the present invention;

FIG. 7B is a flowchart showing an operation of the coding unit shown in FIG. 7A according to Embodiment 1 of the present invention;

FIG. 8 is a flowchart showing an example of a coding condition setting process according to Embodiment 2 of the present invention;

FIG. 9 is a flowchart showing an example of a coding condition setting process according to Embodiment 3 of the present invention;

FIG. 10 is a diagram showing an example of a relation between a coding target image and a reference image according to Embodiment 3 of the present invention; and

FIG. 11 is a flowchart showing an example of a coding condition setting process according to Embodiment 4 of the present invention.

### DESCRIPTION OF THE PREFERRED EMBODIMENT(S)

The following describes embodiments of the present invention with reference to drawings. Although the present invention is described below by way of the embodiments and the attached drawings, this is merely intended for purposes of illustration, and the present invention is not limited to such.

The following embodiments are based on a premise that stereoscopic video is coded according to H.264 MVC. Therefore, MVC is briefly described first. Stereoscopic video mentioned here is video that includes a plurality of images of different viewpoints to convey a stereoscopic perception to a viewer, i.e. video for stereoscopic viewing. For example, by viewing a first viewpoint image (left-eye image) of a first viewpoint included in the stereoscopic video by the left eye and a second viewpoint image (right-eye image) of a second viewpoint included in the stereoscopic video by the right eye, the viewer can stereoscopically view the stereoscopic video.

In MVC, video of each viewpoint is referred to as a “view”, and coding can be performed not only by intra picture prediction and motion compensation (inter prediction) that use only information within a view as in normal H.264 coding, but also by disparity compensation (inter-view prediction) that applies inter frame prediction coding to between views.

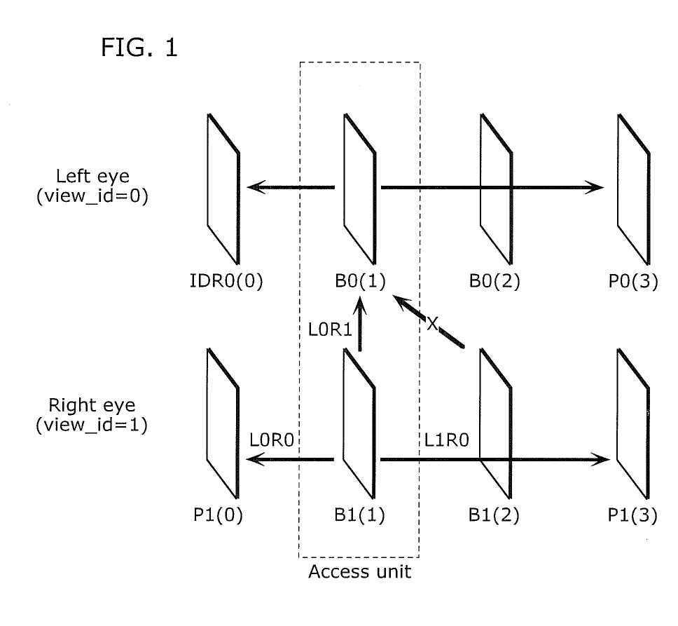

An example of stereoscopic video having two views is described below, with reference to FIG. 1. FIG. 1 is a diagram explaining motion compensation and disparity compensation in H.264 MVC.

A distinction between views in coded images is made using identification information “view_id”. In FIG. 1, view_id=0 is assigned to a left-eye image, whereas view_id=1 is assigned to a right-eye image. The left-eye image assigned view_id=0 is an example of the first viewpoint image of the first viewpoint, and the right-eye image assigned view_id=1 is an example of the second viewpoint image of the second viewpoint.

When coding the left-eye image as a base image, the coding is performed using intra picture prediction and motion compensation as in normal H.264 coding. For instance, a B0(1) picture is motion-compensated using an IDR0(0) picture and a P0(3) picture as reference images.

When coding the right-eye image, on the other hand, disparity compensation can be used in addition to intra picture prediction and motion compensation. For instance, a B1(1) picture is motion-compensated using a P1(0) picture and a P1(3) picture as reference images, and also disparity-compensated using the B0(1) picture in the left-eye view as a reference image.

As a method of designating a reference image, a reference picture list is employed. For example, when coding the B1(1) picture, the P1(0) picture is set in a reference index 0 (L0R0) in a first reference list, the B0(1) picture is set in a reference index 1 (L0R1) in the first reference list, and the P1(3) picture is set in a reference index 0 (L1R0) in a second reference list, as shown in FIG. 1.

MVC stipulates that disparity compensation is only allowed between views located in the same access unit in a stream. As an example, in the case where only the B0(1) picture and the B1(1) picture are located in the same access unit, a B1(2) picture which is an image in a different access unit cannot be disparity-compensated using the B0(1) picture as a reference image, as shown in FIG. 1.

The following describes embodiments of an image coding apparatus and an image coding method according to the present invention that code stereoscopic video according to H.264 MVC mentioned above, with reference to drawings. Note that the image coding apparatus and the image coding method according to the present invention are not limited to H.264 MVC, and may code stereoscopic video according to other 3D coding standards. The other 3D coding standards may include a standard that will be established in the future, as an example. A 3D coding standard mentioned here is a standard whereby an image is separately presented to each of the left and right eyes of the viewer so that the viewer can stereoscopically view video.

### Embodiment 1

An image coding apparatus according to Embodiment 1 is an image coding apparatus that codes stereoscopic video. The image coding apparatus according to Embodiment 1 includes: a control unit that sets a coding mode to one of a 2D coding mode and a 3D coding mode, the 2D coding mode being a mode of coding the stereoscopic video so that, when the coded stereoscopic video is decoded and displayed in 3D, the stereoscopic video is displayed as 2D video, and the 3D coding mode being a mode of coding the stereoscopic video so that, when the coded stereoscopic video is decoded and displayed in 3D, the stereoscopic video is displayed as 3D video; and a coding unit that, in the case where the control unit switches the coding mode from the 3D coding mode to the 2D coding mode, codes the stereoscopic video according to a 3D coding standard when the coding mode is the 3D coding mode, and codes the stereoscopic video according to the 3D coding standard using a coding condition when the coding mode is the 2D coding mode, the coding condition being a condition for causing the stereoscopic video to be viewed as the 2D video when displayed.

Here, the stereoscopic video includes two images that are paired when the stereoscopic video is displayed in 3D. One of the two images includes a first viewpoint image of a first viewpoint, whereas the other one of the two images includes a second viewpoint image of a second viewpoint. The display in 3D is display performed by separately presenting an image to each of the left and right eyes. The 3D video is video stereoscopically viewed by the viewer. The 2D video is video monoscopically viewed by the viewer. The coding condition is a condition for selecting the coding target from the two images that are paired when the stereoscopic video is displayed in 3D and coding the selected coding target.

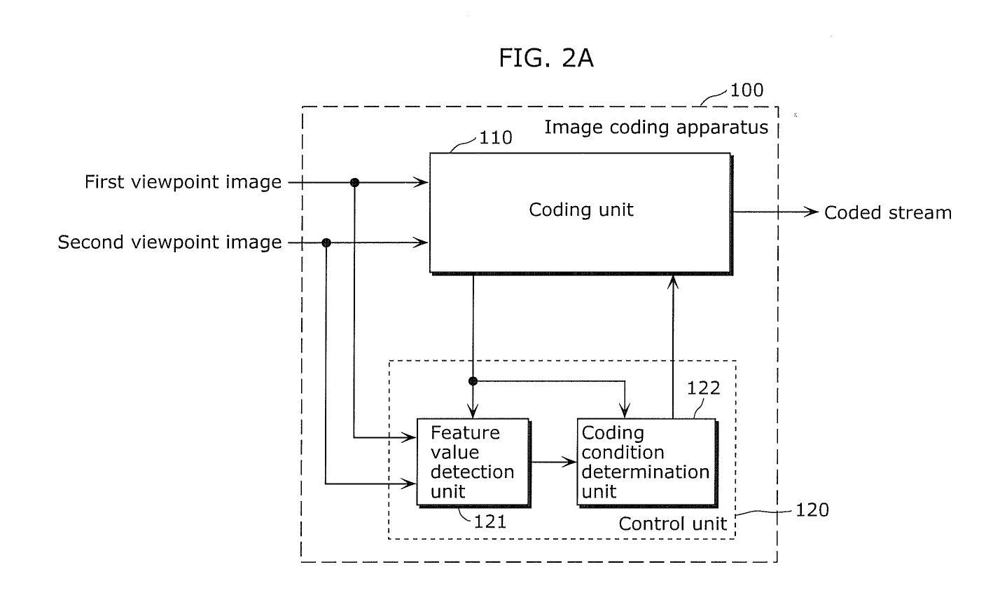

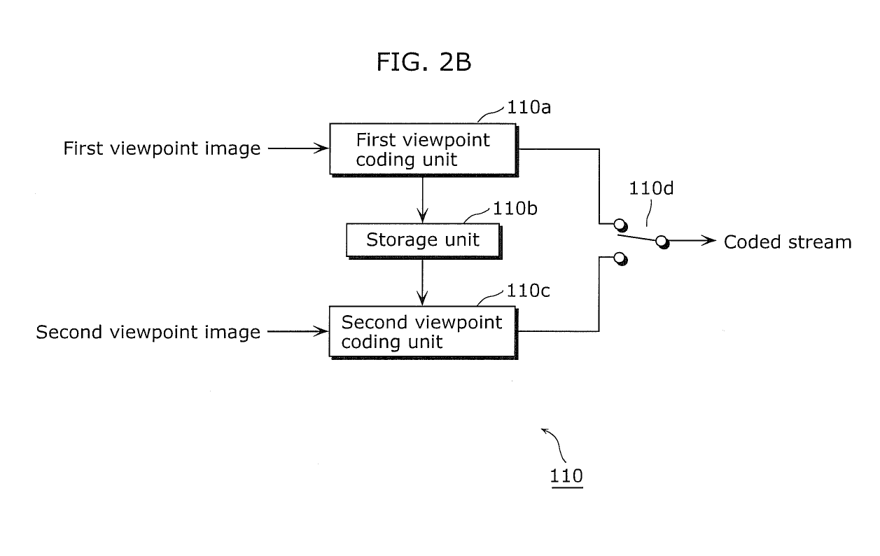

FIGS. 2A and 2B are block diagrams showing an example of a structure of an image coding apparatus 100 according to Embodiment 1. The image coding apparatus 100 codes the stereoscopic video. The stereoscopic video includes the first viewpoint image (e.g. left-eye image) of the first viewpoint and the second viewpoint image (e.g. right-eye image) of the second viewpoint, as noted above. When coding the right-eye image, not only intra picture prediction and motion compensation but also disparity compensation that uses the left-eye image as a reference image can be performed.

As shown in FIG. 2A, the image coding apparatus 100 includes a coding unit 110 and a control unit 120.

The coding unit 110 codes the first viewpoint image and the second viewpoint image according to H.264 MVC, and outputs a coding result as a coded stream. In detail, the coding unit 110 codes the first viewpoint image and the second viewpoint image, using a coding condition determined by the control unit 120.

As shown in FIG. 2B, the coding unit 110 includes a first viewpoint coding unit 110a, a second viewpoint coding unit 110c, a storage unit 110b, and a switching unit 110d.

The first viewpoint coding unit 110a codes one of the two images that are paired when the stereoscopic video is displayed in 3D. This image includes the first viewpoint image, and is coded without reference to the other image. The first viewpoint coding unit 110a also stores a decoded image generated by coding and decoding the image, in the storage unit 110b as a reference image. The second viewpoint coding unit 110c codes the other one of the two images that are paired when the stereoscopic video is displayed in 3D. The other image includes the second viewpoint image. When coding the other image, the second viewpoint coding unit 110c performs the coding with reference to the reference image stored in the storage unit 110b. That is, the other image is coded using disparity compensation. The switching unit 110d switches between the coded image generated as a result of coding by the first viewpoint coding unit 110a and the coded image generated as a result of coding by the second viewpoint coding unit 110c, and outputs the coded image. Thus, the stereoscopic video is coded according to the 3D coding standard and the coded stream is outputted.

In the case where the control unit 120 switches the coding mode from the 3D coding mode to the 2D coding mode, the coding unit 110 codes the stereoscopic video according to the 3D coding standard when the coding mode is the 3D coding mode, and codes the stereoscopic video according to the 3D coding standard using the coding condition when the coding mode is the 2D coding mode, the coding condition being a condition for causing the stereoscopic video to be viewed as the 2D video when displayed. Here, the 2D coding mode is a mode of coding the stereoscopic video so that, when the coded stereoscopic video is decoded and displayed in 3D, the stereoscopic video is displayed as 2D video. The 3D coding mode is a mode of coding the stereoscopic video so that, when the coded stereoscopic video is decoded and displayed in 3D, the stereoscopic video is displayed as 3D video.

The control unit 120 sets the coding mode to one of the 2D coding mode and the 3D coding mode. Here, the control unit 120 sets the coding mode, based on an image feature value relating to viewer fatigue when the coded stereoscopic video is decoded and displayed in 3D. The control unit 120 also determines the coding condition of the first viewpoint image and the second viewpoint image. For instance, the control unit 120 determines the coding condition on a picture-by-picture basis. That is, the control unit 120 determines the coding condition of a first picture (first viewpoint image) of the first viewpoint and a second picture (second viewpoint image) of the second viewpoint. The first picture and the second picture are, for example, images captured at the same image capture time, and are located in the same access unit.

As shown in FIG. 2A, the control unit 120 includes a feature value detection unit 121 and a coding condition determination unit 122. The control unit 120 controls the coding unit 110 so that the coding unit 110 performs coding according to the coding condition determined by the coding condition determination unit 122 based on the image feature value detected by the feature value detection unit 121.

The feature value detection unit 121 detects the image feature value based on pixel data included in the stereoscopic video. That is, the feature value detection unit 121 detects the image feature value of the first viewpoint image and the second viewpoint image. Here, the feature value detection unit 121 detects an amount of disparity between the first viewpoint image and the second viewpoint image, as an example of the image feature value.

The image feature value is a feature value relating to a degree of viewer fatigue, as mentioned above. The degree of viewer fatigue indicates a degree of biological strain the viewer feels when viewing the stereoscopic video. For instance, the image feature value is larger when the degree of viewer fatigue is larger. As an example, a large amount of disparity between the first viewpoint image and the second viewpoint image causes an increase in the degree of viewer fatigue.

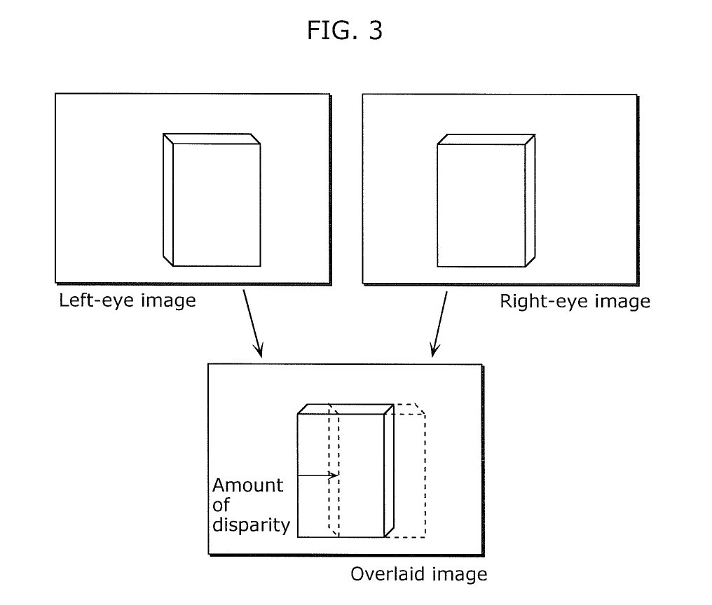

A disparity is described below, with reference to FIG. 3. As shown in FIG. 3, when an object viewed by the right eye and an object viewed by the left eye are overlaid with each other, there is a displacement in horizontal position between the object viewed by the right eye and the object viewed by the left eye in an image (overlaid image) at the bottom of FIG. 3. This displacement is the disparity, and the amount of displacement is the amount of disparity.

The amount of disparity is detected as follows. As in a process of calculating a motion vector for each macroblock (hereafter, MB) in motion compensation, a motion vector of the object in the right-eye image is calculated with reference to the left-eye image, as the amount of disparity. There are various motion vector calculation methods, and the present invention is not limited to any particular method.

The amount of disparity is detected only between the views located in the same access unit. The two view images located in the same access unit are two images that are paired when the stereoscopic video is displayed in 3D. In other words, the two view images are two images displayed at the same time or substantially at the same time. Though the above describes the case where the motion vector of the object is detected as the amount of disparity, the amount of disparity may instead be a mean value or a maximum value of motion vectors of MBs, or a mean vector of MBs each having a motion vector equal to or more than a given threshold.

Though the above describes an example where the feature value detection unit 121 detects the amount of disparity as the image feature value, the feature value detection unit 121 may instead detect an amount of motion in a time axis direction as the image feature value. In this case, the feature value detection unit 121 performs normal motion detection, to detect the amount of motion in the time axis direction in at least one of the first viewpoint image and the second viewpoint image. A large amount of motion in the time axis direction in at least one of the first viewpoint image and the second viewpoint image also causes an increase in the degree of viewer fatigue when viewing the stereoscopic video.

Here, the feature value detection unit 121 may detect the amount of motion in the time axis direction from a motion vector of an already coded image, as the image feature value. Alternatively, the feature value detection unit 121 may use information of pan, tilt, zoom, and the like or disparity information from among information detected at the time of image capture by a camera. As an example, pan information enables obtainment of a speed of horizontal movement of the camera, so that the feature value detection unit 121 can detect the amount of motion in the time axis direction from the obtained speed and a frame rate.

The coding condition determination unit 122 determines whether the first viewpoint image and the second viewpoint image are to be coded as a 3D image or a 2D image, based on the image feature value (the amount of disparity or the amount of motion) of at least one of the first viewpoint image and the second viewpoint image detected by the feature value detection unit 121. That is, the coding condition determination unit 122 sets the coding mode to either the 2D coding mode or the 3D coding mode, based on the image feature value detected by the feature value detection unit 121. In the case of setting the coding mode to the 2D coding mode, the coding condition determination unit 122 determines the coding condition for causing the stereoscopic video to be viewed as 2D video when displayed.

Coding the first viewpoint image and the second viewpoint image as a 3D image means, for example, coding the first viewpoint image and the second viewpoint image so that there is a disparity between the coded image of the first viewpoint image and the coded image of the second viewpoint image. This also means coding the stereoscopic video so that, when the coded stereoscopic video is decoded and displayed in 3D, the stereoscopic video is displayed as 3D video. Meanwhile, coding the first viewpoint image and the second viewpoint image as a 2D image means, for example, coding the first viewpoint image and the second viewpoint image so that there is no disparity between the coded image of the first viewpoint image and the coded image of the second viewpoint image. This also means coding the stereoscopic video so that, when the coded stereoscopic video is decoded and displayed in 3D, the stereoscopic video is displayed as 2D video.

In the case of determining to code the first viewpoint image and the second viewpoint image as a 2D image, the coding condition determination unit 122 determines the coding condition of the first viewpoint image and the second viewpoint image so that the first viewpoint image and the second viewpoint image are coded as images identical to each other, substantially identical to each other, or similar to each other. That is, the coding condition determination unit 122 determines the coding condition so that the first viewpoint image and the second viewpoint image are coded as images closer to be identical to each other in the case of setting the coding mode to the 2D coding mode, than in the case of setting the coding mode to the 3D coding mode.

For instance, in the case where the image feature value (the amount of disparity or the amount of motion) is larger than a predetermined threshold, the coding condition determination unit 122 determines to code the first viewpoint image and the second viewpoint image as a 2D image. In detail, on the ground that the degree of viewer fatigue increases in the case where the image feature value is larger than the threshold, the coding condition determination unit 122 determines the coding condition so that the first viewpoint image and the second viewpoint image are coded as identical images only for each picture exceeding the threshold from among a plurality of pictures included in the stereoscopic video.

In other words, in the case where the image feature value is larger than the threshold, the coding condition determination unit 122 determines the coding condition so that the coded image of the first viewpoint image and the coded image of the second viewpoint image are identical images or substantially identical images. A coded image mentioned here is an image generated by decoding a coding result (coded stream). A coding condition determination process will be described in detail later. The coding condition has two types, namely, a coding parameter and coding target image selection. The coding parameter is a parameter used for coding two images that are paired when the stereoscopic video is displayed in 3D. The coding target image selection is selection of a coding target image from the two images that are paired when the stereoscopic video is displayed in 3D. Thus, there are two cases, namely, the case where the two images are selected as the coding target, and the case where one of the two images and an image identical to the one of the two images are selected as the coding target. When the coding condition is the coding target image selection, the coding unit 110 codes two images selected as the coding target, according to the normal 3D coding standard.

Note that, depending on the above threshold, there is a possibility that the input signal frequently switches between the mode of coding as a 2D image and the mode of coding as a 3D image. This causes more eye fatigue than when viewing normal 3D video. To avoid such a situation, the threshold may be given a hysteresis property. In detail, when the input signal selects the mode of coding as a 2D image, the threshold is changed to increase a probability of selecting the mode of coding as a 2D image next time. Hence, the threshold can be changed based on the selected coding mode.

This reduces the possibility that the coding mode is frequency switched between the mode of coding as a 2D image and the mode of coding as a 3D image. Alternatively, a structure of setting the coding condition so that the coding mode is not switched for a fixed period of time may be adopted.

The following describes an example of an operation of the image coding apparatus 100 according to Embodiment 1.

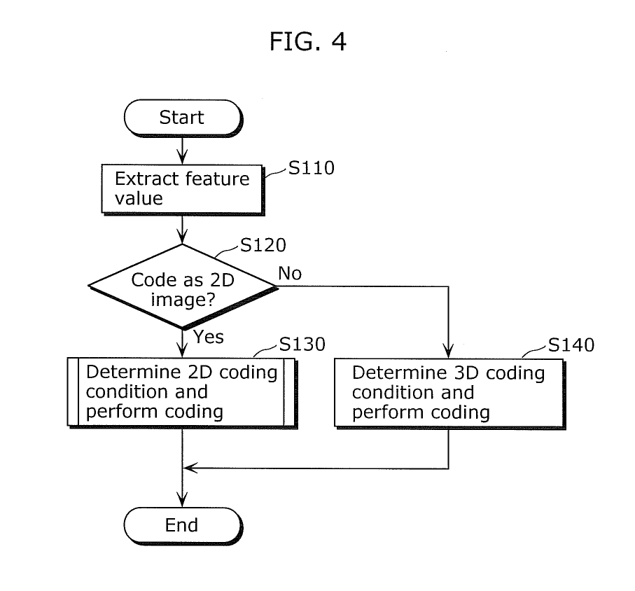

FIG. 4 is a flowchart showing an example of an operation of the image coding apparatus 100 according to Embodiment 1.

First, the image coding apparatus 100 obtains the first viewpoint image and the second viewpoint image, and the feature value detection unit 121 detects the image feature value using the first viewpoint image and the second viewpoint image (Step S110).

For instance, the feature value detection unit 121 detects the amount of disparity between the first viewpoint image and the second viewpoint image, as the image feature value.

Next, the coding condition determination unit 122 determines whether or not to code the first viewpoint image and the second viewpoint image as a 2D image (Step S120). That is, the coding condition determination unit 122 determines whether or not to set the coding mode to the 2D coding mode. In detail, the coding condition determination unit 122 determines whether or not the image feature value detected by the feature value detection unit 121 is larger than the predetermined threshold.

In the case where the image feature value is larger than the threshold, the coding condition determination unit 122 determines to code the first viewpoint image and the second viewpoint image as a 2D image. That is, the coding condition determination unit 122 sets the coding mode to the 2D coding mode. In the case where the image feature value is not larger than the threshold, the coding condition determination unit 122 determines to code the first viewpoint image and the second viewpoint image as a 3D image. That is, the coding condition determination unit 122 sets the coding mode to the 3D coding mode.

In other words, the coding condition determination unit 122 determines whether or not the viewer feels fatigue such as eye strain when the first viewpoint image and the second viewpoint image are displayed as a 3D image. A larger amount of disparity than the threshold or a larger amount of motion in the time axis direction than the threshold puts heavy strain on the viewer's eyes, causing the viewer to feel significant fatigue. Therefore, in the case where the amount of disparity or the amount of motion is larger than the threshold, the coding condition determination unit 122 determines to code the first viewpoint image and the second viewpoint image as a 2D image so as not to put strain on the viewer.

In the case of determining to code the first viewpoint image and the second viewpoint image as a 2D image (Step S120: Yes), the coding condition determination unit 122 determines a 2D coding condition, and the coding unit 110 codes the first viewpoint image and the second viewpoint image according to the determined coding condition (Step S130). The 2D coding condition is a coding condition for causing the stereoscopic video to be viewed as 2D video when displayed. In detail, the coding condition determination unit 122 determines such a coding condition that the first viewpoint image and the second viewpoint image are coded as identical images or substantially identical images. The coding condition will be described in detail later.

In the case of determining to code the first viewpoint image and the second viewpoint image as a 3D image (Step S120: No), the coding condition determination unit 122 determines a 3D coding condition, and the coding unit 110 codes the first viewpoint image and the second viewpoint image according to the determined coding condition (Step S140). In detail, the coding condition determination unit 122 determines a coding condition that complies with H.264 MVC, and the coding unit 110 codes the first viewpoint image and the second viewpoint image according to the determined coding condition.

The above operation is executed for each access unit, i.e. for each picture pair (the first picture and the second picture).

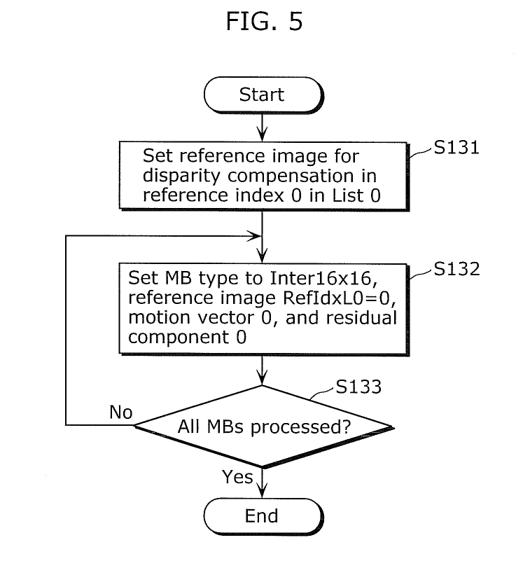

The following describes an example of a coding parameter for making the two coded images identical to each other, as the 2D coding condition, i.e. the coding condition for causing the stereoscopic video to be viewed as 2D video when displayed. FIG. 5 is a flowchart showing an example of a coding condition setting process according to Embodiment 1. In detail, FIG. 5 shows a process (Step S130 in FIG. 4) of determining a coding condition of the second viewpoint image (right-eye image) which is disparity-compensated.

First, the coding condition determination unit 122 sets the first viewpoint image which is a reference image, in the reference index 0 in List 0 (Step S131). List 0 mentioned here is an example of the first reference list. The first reference list is a list for designating a reference image used for L0 prediction that can be performed when coding a B picture or a P picture. It is possible to set a picture used as a reference image in each reference index number (starting from 0).

The reference index 0 enhances coding efficiency, because the amount of code when coding is performed is smallest. That is, the coding condition determination unit 122 preferably sets the first viewpoint image in such a reference index in the reference list that maximizes coding efficiency.

Next, the coding condition determination unit 122 sets a MB type of a MB in the second viewpoint image which is the coding target image, to Inter16×16, and determines a coding condition that a reference image is only the first viewpoint image set in the reference index 0 in List 0, a motion vector is 0, and a residual component (residual) is 0 (Step S132). The coding unit 110 codes the target MB according to the determined coding condition.

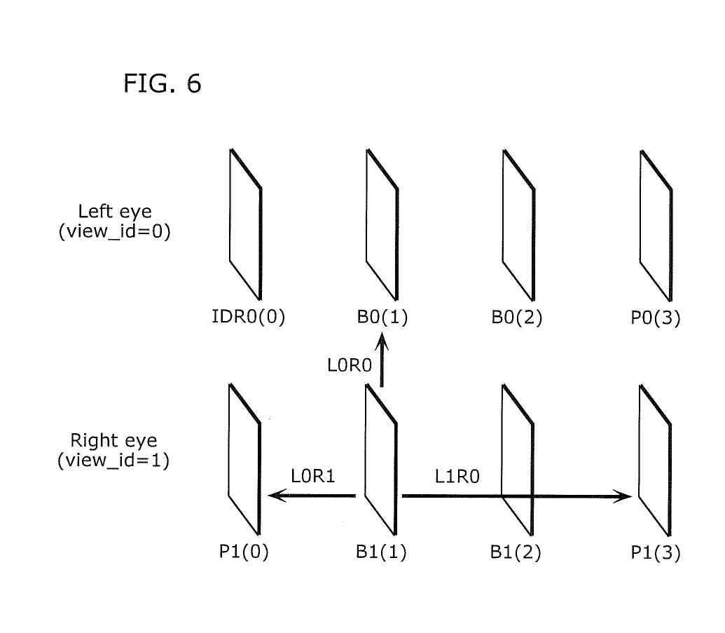

For example, in the case of making the B0(1) picture (first viewpoint image) and the B1(1) picture (second viewpoint image) in FIG. 6 as identical coded images, the coding condition determination unit 122 determines such a coding condition that performs disparity compensation between the two pictures. In more detail, using the left-eye image as a base image, the coding condition determination unit 122 sets the B0(1) picture in the reference index 0 (L0R0) in List 0, and determines the coding condition that only the B0(1) picture is used as a reference image for a MB in the B1(1) picture. The coding condition determination unit 122 also forcefully sets the coding condition that a motion vector is 0 and a residual is 0.

This allows the coded image of the B1(1) picture and the coded image of the B0(1) picture to be identical to each other. Here, setting the MB type to Inter16×16 means that, in a H.264 syntax, the MB type is set to P_L0_{—}16×16 in the case of a P picture and B_L0_{—}16×16 in the case of a B picture.

The above coding condition determination process (Step S132) is repeated (Step S133: No) until all MBs included in the second viewpoint image are processed.

In the example shown in FIG. 6, in the case of coding the B1(1) picture, the B0(1) picture is set in the reference index 0 (L0R0) in the first reference list, the P1(0) picture is set in the reference index 1 (L0R1) in the first reference list, and the P1(3) picture is set in the reference index 0 (L1R0) in the second reference list. When actually coding the B1(1) picture, however, only the B0(1) picture set in the reference index 0 (L0R0) in the first reference list is referenced. Hence, it is sufficient to only set the B0(1) picture in the reference index 0 (L0R0) in the first reference list.

The following describes the case where the coding condition is the coding target image selection mentioned above. In this case, the 2D coding condition is that one of the two images that are paired when the stereoscopic video is displayed in 3D and an image identical to the one of the two images are selected as the coding target. In other words, the 2D coding condition is that one of the two images that are paired when the stereoscopic video is displayed in 3D is replaced with the other one of the two images. Hence, the coding condition determination unit 122 determines, as the 2D coding condition, that one of the two images that are paired when the stereoscopic video is displayed in 3D is replaced with the other one of the two images. The coding unit 110 replaces the image with the other image according to the 2D coding condition, and codes two images resulting from the replacement according to the 3D coding standard.

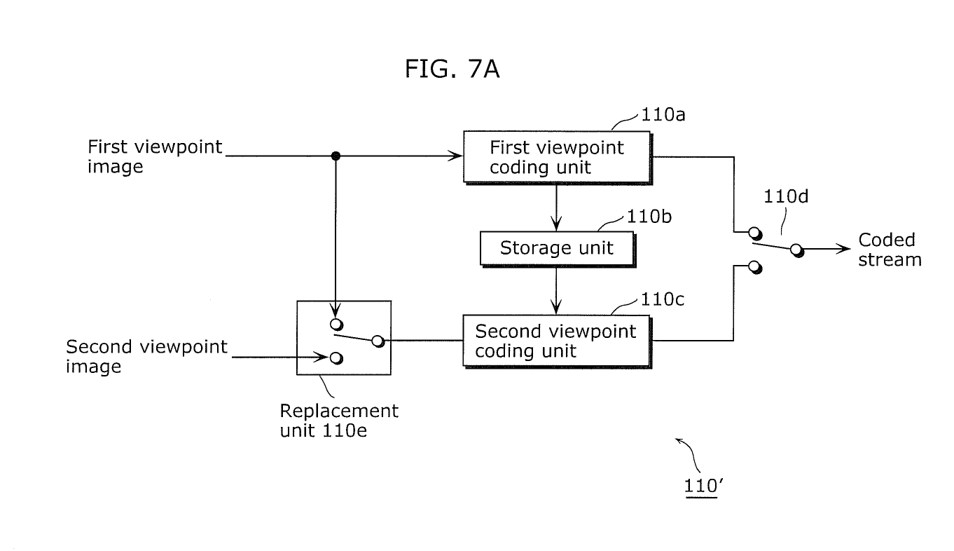

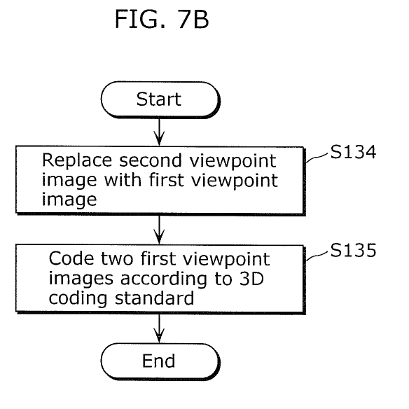

FIG. 7A is a block diagram showing an example of a structure of a coding unit that replaces the coding target image according to the coding condition and codes the replaced coding target image. A coding unit 110′ shown in FIG. 7A includes the first viewpoint coding unit 110a, the second viewpoint coding unit 110c, the storage unit 110b, the switching unit 110d, and a replacement unit 110e. The replacement unit 110e obtains the two images that are paired when the stereoscopic video is displayed in 3D, namely, the first viewpoint image and the second viewpoint image. In the case where the 2D coding condition is not determined, the replacement unit 110e outputs the second viewpoint image to the second viewpoint coding unit 110c as the coding target image. In the case where the 2D coding condition is determined, on the other hand, the replacement unit 110e replaces the second viewpoint image with the first viewpoint image, and outputs the first viewpoint image to the second viewpoint coding unit 110c as the coding target image.

FIG. 7B is a flowchart showing an operation of the coding unit 110′.

Upon receiving notification of the determined 2D coding condition from the coding condition determination unit 122, the replacement unit 110e in the coding unit 110′ replaces one image with the other image according to the 2D coding condition. In detail, the replacement unit 110e replaces the second viewpoint image with the first viewpoint image (Step S134). The replacement unit 110e then outputs the first viewpoint image to the second viewpoint coding unit 110c. As a result, the first viewpoint coding unit 110a and the second viewpoint coding unit 110c code the two first viewpoint images according to the 3D coding standard (Step S135).

As described above, the image coding apparatus 100 according to Embodiment 1 sets the coding mode to one of the 2D coding mode and the 3D coding mode. In the case of switching the coding mode from the 3D coding mode to the 2D coding mode, the image coding apparatus 100 codes the stereoscopic video according to the 3D coding standard when the coding mode is the 3D coding mode, and codes the stereoscopic video according to the 3D coding standard using the coding condition when the coding mode is the 2D coding mode, the coding condition being a condition for causing the stereoscopic video to be viewed as the 2D video when displayed. For example, the image coding apparatus 100 sets the coding mode, based on the image feature value relating to the degree of viewer fatigue when the coded stereoscopic video is decoded and displayed in 3D. That is, the image coding apparatus 100 detects the image feature value based on pixel data included in the stereoscopic video. The image coding apparatus 100 sets the coding mode based on the detected image feature value and, in the case of setting the coding mode to the 2D coding mode, determines the coding condition for causing the stereoscopic video to be viewed as 2D video.

In detail, one of the two images that are paired when the stereoscopic video is displayed in 3D includes the first viewpoint image of the first viewpoint, and the other one of the two images includes the second viewpoint image of the second viewpoint different from the first viewpoint. Here, the image coding apparatus 100 determines the coding condition for causing the stereoscopic video to be viewed as 2D video so that the first viewpoint image and the second viewpoint image are coded as images closer to be identical to each other in the case of setting the coding mode to the 2D coding mode, than in the case of setting the coding mode to the 3D coding mode. In other words, the image coding apparatus 100 determines whether the first viewpoint image and the second viewpoint image are to be coded as a 3D image or a 2D image, based on the image feature value of at least one of the first viewpoint image and the second viewpoint image. In the case of determining to code the first viewpoint image and the second viewpoint image as a 2D image, the image coding apparatus 100 determines the coding condition of the first viewpoint image and the second viewpoint image so that the first viewpoint image and the second viewpoint image are coded as identical images.

In more detail, the image coding apparatus 100 according to Embodiment 1 sets the first viewpoint image in a predetermined reference index in the first reference list, and determines the coding condition that a reference image is only the first viewpoint image set in the reference index, a motion vector is 0, and a residual is 0, as a coding condition of a macroblock included in the second viewpoint image.

Alternatively, the image coding apparatus 100 determines the coding condition that one of the two images that are paired when the stereoscopic video is displayed in 3D is replaced with the other one of the two images, as the coding condition for causing the stereoscopic video to be viewed as 2D video. The image coding apparatus 100 replaces the one of the two images with the other one of the two images according to the coding condition, and codes two images resulting from the replacement according to the 3D coding standard.

A larger image feature value than the threshold can be regarded as indicating a large degree of viewer fatigue when viewing 3D video. In the case where the degree of viewer fatigue is large, the image coding apparatus 100 according to Embodiment 1 determines the coding condition so that the first viewpoint image and the second viewpoint image are coded as identical images or substantially identical images, thereby coding the stereoscopic video as 2D video.

Moreover, in the case where it is preferable to code the first viewpoint image and the second viewpoint image partially as a 2D image while coding the first viewpoint image and the second viewpoint image as a 3D image, the image coding apparatus 100 codes the first viewpoint image and the second viewpoint image as a 2D image.

Thus, the image coding apparatus 100 according to Embodiment 1 can record the stereoscopic video partially as 2D video so as to enable display to be performed while seamlessly switching between 3D video and 2D video. For instance, a scene that tends to cause eye fatigue in the stereoscopic video can be recorded as 2D video. Since the first viewpoint image and the second viewpoint image are coded as one file (video data) that partially includes 2D video, display can be performed while seamlessly switching between 3D video and 2D video.

### Embodiment 2

Embodiment 2 describes another coding condition (coding parameter) for making the coded images identical to each other, using the structure described in Embodiment 1. The same premise as in Embodiment 1 also applies to Embodiment 2. The following describes a coding condition determination process in the case of determining to code the first viewpoint image and the second viewpoint image as a 2D image. Since other operations are the same as those in Embodiment 1, their description is omitted.

When setting the coding mode to the 2D coding mode, i.e. when determining to code the first viewpoint image and the second viewpoint image as a 2D image, the image coding apparatus according to Embodiment 2 sets the coding type of all macroblocks included in the second viewpoint image to a skip macroblock in the case where the picture type of the second viewpoint image is a P picture. In the case where the picture type of the second viewpoint image is a B picture, on the other hand, the image coding apparatus changes, for each macroblock included in the second viewpoint image, whether or not to set the coding type of the macroblock to a skip macroblock, depending on a neighboring macroblock type.

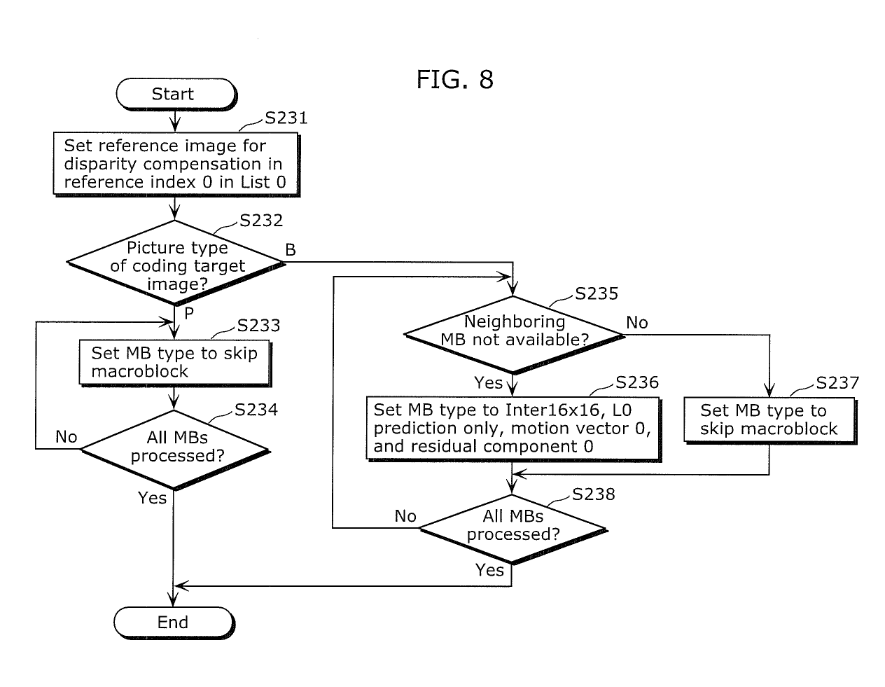

FIG. 8 is a flowchart showing an example of a coding condition setting process according to Embodiment 2.

First, the coding condition determination unit 122 sets the first viewpoint image which is a reference image, in the reference index 0 in List 0, as in Embodiment 1 (Step S231).

Next, the coding condition determination unit 122 determines the picture type of the coding target image (second viewpoint image) (Step S232). In the case where the picture type of the coding target image is P (Step S232: P), the coding condition determination unit 122 determines a coding condition that the coding type (MB type) of a MB included in the second viewpoint image is a skip macroblock (Step S233). The coding unit 110 codes the target MB according to the determined coding condition.

The above coding condition determination process and coding process (Step S233) are repeated (Step S234: No) until all MBs included in the second viewpoint image are processed.

A skip macroblock mentioned here is a macroblock that is coded in accordance with motion in its neighborhood. In detail, the target MB which is a skip macroblock is coded under a condition that a motion vector of the target MB is a median value of motion vectors of neighboring MBs of the target MB and a residual is 0.

A situation where the target MB which is a skip macroblock is a MB for which neighboring MB information is unusable, e.g. a top left MB in the picture, is described below. In such a situation, if the target MB is a P picture, the target MB is coded under a condition that a reference image is the first viewpoint image set in the reference index 0 (L0R0) in the first reference list, a motion vector is 0, and a residual is 0. Accordingly, by setting the first viewpoint image in the reference index 0 in the first reference list and setting the coding type of all MBs included in the second viewpoint image as a skip macroblock as mentioned above, the first viewpoint image and the second viewpoint image can be coded so as to be identical to each other.

In the case where the picture type of the coding target image is B (Step S232: B), the coding condition determination unit 122 determines whether or not information of the neighboring MBs of the target MB is unusable, that is, whether or not the target MB is a MB whose neighboring MBs are not available (Step S235). In more detail, the coding condition determination unit 122 determines whether or not the target MB is the top left MB in the second viewpoint image.

In the case where the neighboring MBs are not available (Step S235: Yes), the coding condition determination unit 122 determines a coding condition that the MB type of the target MB is Inter16×16, a reference image is only the first viewpoint image in the reference index 0 in List 0, a motion vector is 0, and a residual is 0 (Step S236).

The coding unit 110 codes the target MB according to the determined coding condition.

In the case where the neighboring MBs are available (Step S235: No), the coding condition determination unit 122 determines a coding condition that the MB type of the target MB is a skip macroblock (Step S237). The coding unit 110 codes the target MB according to the determined coding condition.

The above coding condition determination process and coding process (Steps S235 to S237) are repeated (Step S238: No) until all MBs included in the second viewpoint image are processed.

In the case where the picture type of the coding target image is a B picture, if the coding type of the target MB whose neighboring MBs are not available is set to a skip macroblock, bidirectional prediction where the motion vector is 0 is performed, making it impossible to obtain identical coded images. In detail, the target MB is coded as a mean value of a reference MB in the first viewpoint image set in the reference index 0 in the first reference list and a reference MB in an image (typically, different from the first viewpoint image) set in the reference index 0 in the second reference list.

Given that the top left MB in the picture is in such a state, if the coding type of all MBs included in the second viewpoint image is set to a skip macroblock, bidirectional prediction where the motion vector is 0 will end up being performed in the same manner as the top left MB in the picture. To avoid this, the MB type is changed according to the neighboring MB status in Embodiment 2. For a MB for which neighboring MB information is unusable, the same coding condition as in Embodiment 1 is set so as to forcefully code the MB as an image identical to the MB in the first viewpoint image. Note that, in the case where the picture includes a plurality of slices, a top left MB in each slice may be treated as a MB for which neighboring MB information is unusable.

As described above, when determining to code the first viewpoint image and the second viewpoint image as a 2D image, the image coding apparatus according to Embodiment 2 sets the coding type of all MBs included in the second viewpoint image to a skip macroblock in the case where the picture type of the second viewpoint image is a P picture. In the case where the picture type of the second viewpoint image is a B picture, on the other hand, the image coding apparatus sets the same coding condition as in Embodiment 1 for a MB for which neighboring MB information is unusable, and sets a coding condition for each of the other MBs that the coding type of the MB is a skip macroblock.

Thus, the image coding apparatus according to Embodiment 2 can record the stereoscopic video partially as 2D video so as to enable display to be performed while seamlessly switching between 3D video and 2D video, as in Embodiment 1. For instance, a scene that tends to cause eye fatigue in the stereoscopic video can be recorded as 2D video. This enables display to be performed while seamlessly switching between 3D video and 2D video. Moreover, according to Embodiment 2, it is only necessary to code information that most MBs are skip macroblocks, which enhances coding efficiency.

### Embodiment 3

Embodiment 3 describes another coding condition (coding parameter) for making the coded images identical to each other, using the structure described in Embodiment 1. The same premise as in Embodiment 1 also applies to Embodiment 3. The following describes a coding condition determination process in the case of determining to code the first viewpoint image and the second viewpoint image as a 2D image. Since other operations are the same as those in Embodiment 1, their description is omitted.

When setting the coding mode to the 2D coding mode, i.e. when determining to code the first viewpoint image and the second viewpoint image as a 2D image, the image coding apparatus according to Embodiment 3 sets the first viewpoint image not only in the reference index 0 in the first reference list but also in the reference index 0 in the second reference list and sets the coding type of all macroblocks included in the second viewpoint image to a skip macroblock, in the case where the picture type of the second viewpoint image is a B picture.

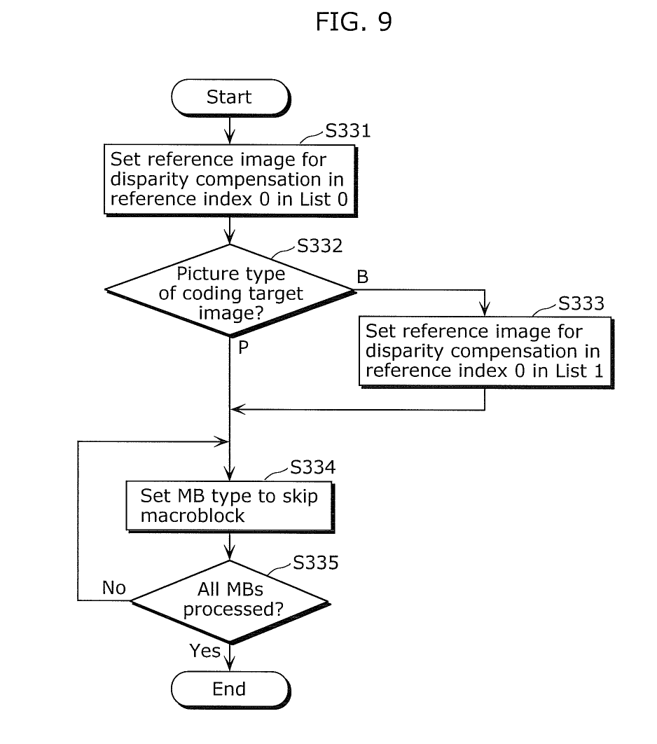

FIG. 9 is a flowchart showing an example of a coding condition setting process according to Embodiment 3.

First, the coding condition determination unit 122 sets the first viewpoint image which is a reference image, in the reference index 0 in List 0 as the first reference list, as in Embodiment 1 (Step S331).

Next, the coding condition determination unit 122 determines the picture type of the coding target image (second viewpoint image) (Step S332). In the case where the picture type of the coding target image is B (Step S332: B), the coding condition determination unit 122 sets the first viewpoint image set in the reference index 0 in List 0, also in the reference index 0 in List 1 (Step S333).

List 1 mentioned here is an example of the second reference list. The second reference list is a list for designating a reference image used for L1 prediction that can be performed when coding a B picture. It is possible to set a picture used as a reference image in each reference index number (starting from 0).

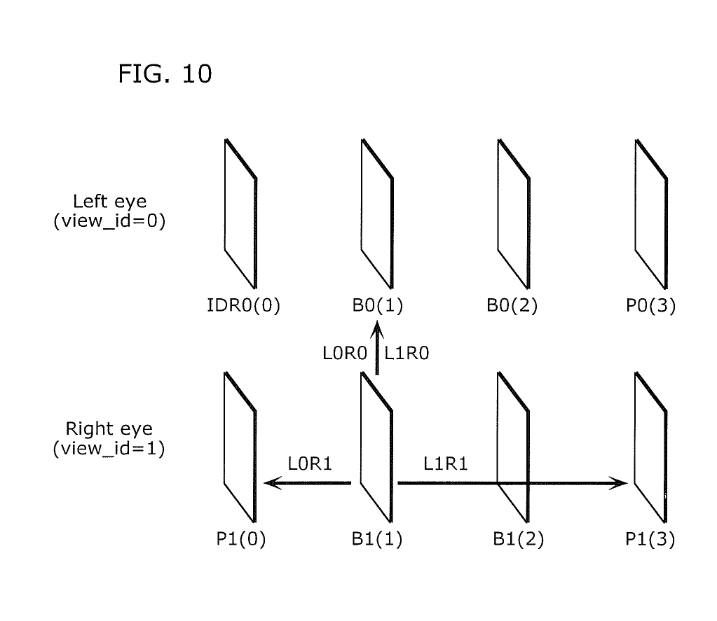

For example, as shown in FIG. 10, in the case of coding the B1(1) picture which is the second viewpoint image, the B0(1) picture is set in the reference index 0 (L0R0) in the first reference list, and also set in the reference index 0 (L1R0) in the second reference list. Thus, the same reference image is indicated by a plurality of reference indexes.

The coding condition determination unit 122 then determines a coding condition that the MB type of a MB in the coding target image (second viewpoint image) is a skip macroblock, regardless of the coding type of the MB in the coding target image (Step S334). The coding unit 110 codes the target MB according to the determined coding condition.

The above coding condition determination process and the coding process (Step S334) are repeated (Step S335: No) until all MBs included in the second viewpoint image are processed.

In the example shown in FIG. 10, in the case of coding the B1(1) picture, the P1(0) picture is set in the reference index 1 (L0R1) in the first reference list, and the P1(3) picture is set in the reference index 1 (L1R1) in the second reference list. When actually coding the B1(1) picture, however, only the B0(1) picture set in the reference index 0 (L0R0) in the first reference list and the reference index 0 (L1R0) in the second reference list is referenced. Hence, it is sufficient to only set the B0(1) picture in the reference index 0 (L0R0) in the first reference list and the reference index 0 (L1R0) in the second reference list.

As described above, when determining to code the first viewpoint image and the second viewpoint image as a 2D image, the image coding apparatus 100 according to Embodiment 3 sets the first viewpoint image not only in the reference index 0 in the first reference list but also in the reference index 0 in the second reference list, and determines the coding condition that the coding type of all MBs included in the second viewpoint image is a skip macroblock.

This eliminates the need to determine the type of the MB included in the second viewpoint image, as a result of which the processing amount can be reduced. Moreover, it is only necessary to code information that all MBs included in the second viewpoint image are skip macroblocks, which enhances coding efficiency. The image coding apparatus 100 according to Embodiment 3 can record the stereoscopic video partially as 2D video so as to enable display to be performed while seamlessly switching between 3D video and 2D video, as in Embodiment 1. For instance, a scene that tends to cause eye fatigue in the stereoscopic video can be recorded as 2D video, enabling display to be performed while seamlessly switching between 3D video and 2D video.

### Embodiment 4

Embodiment 4 describes another coding condition (coding parameter) for making the coded images identical to each other, using the structure described in Embodiment 1. The same premise as in Embodiment 1 also applies to Embodiment 4. The following describes a coding condition determination process in the case of determining to code the first viewpoint image and the second viewpoint image as a 2D image. Since other operations are the same as those in Embodiment 1, their description is omitted.

When setting the coding mode to the 2D coding mode, i.e. when determining to code the first viewpoint image and the second viewpoint image as a 2D image, the image coding apparatus according to Embodiment 4 changes the picture type of the second viewpoint image to a P picture and sets the coding type of all macroblocks included in the second viewpoint image to a skip macroblock, in the case where the picture type of the second viewpoint image is a B picture.

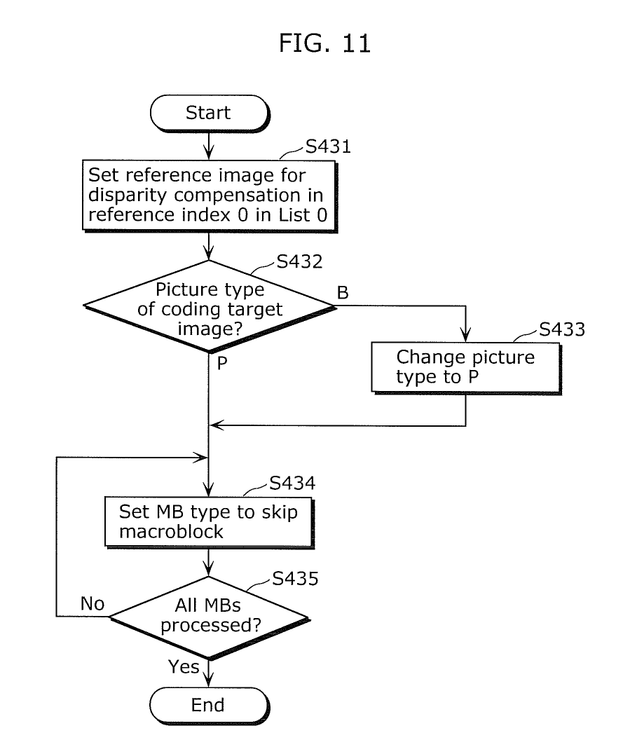

FIG. 11 is a flowchart showing an example of a coding condition setting process according to Embodiment 4.

First, the coding condition determination unit 122 sets the first viewpoint image which is a reference image, in the reference index 0 in List 0, as in Embodiment 1 (Step S431).

Next, the coding condition determination unit 122 determines the picture type of the coding target image (second viewpoint image) (Step S432). In the case where the picture type of the coding target image is B (Step S432: B), the coding condition determination unit 122 forcefully changes the picture type of the coding target image to P (Step S433).

The coding condition determination unit 122 then determines a coding condition that the MB type of a MB in the coding target image (second viewpoint image) is a skip macroblock (Step S434). The coding unit 110 codes the target MB according to the determined coding condition.

The above coding condition determination process and the coding process (Step S434) are repeated (Step S435: No) until all MBs included in the second viewpoint image are processed.

As described above, when determining to code the first viewpoint image and the second viewpoint image as a 2D image, the image coding apparatus 100 according to Embodiment 4 changes the picture type of the second viewpoint image to a P picture in the case where the picture type of the second viewpoint image is a B picture, and determines the coding condition that the coding type of all MBs included in the second viewpoint image is a skip macroblock.

This eliminates the need to determine the type of the MB included in the second viewpoint image, as a result of which the processing amount can be reduced. Moreover, it is only necessary to code information that all MBs included in the second viewpoint image are skip macroblocks, which enhances coding efficiency. The image coding apparatus 100 according to Embodiment 3 can record the stereoscopic video partially as 2D video so as to enable display to be performed while seamlessly switching between 3D video and 2D video, as in Embodiment 1. For instance, a scene that tends to cause eye fatigue in the stereoscopic video can be recorded as 2D video, enabling display to be performed while seamlessly switching between 3D video and 2D video.

Though the image coding apparatus and the image coding method according to the present invention have been described by way of the above embodiments, the present invention is not limited to the above embodiments. Modifications obtained by applying various changes conceivable by those skilled in the art to the embodiments and any combinations of components in different embodiments are also included in the present invention without departing from the scope of the present invention.

For example, though each of the above embodiments describes progressive 3D video, the present invention is also applicable to interlaced 3D video. In this case, a top field of the left-eye image and a top field of the right-eye image are located in one access unit, while a bottom field of the left-eye image and a bottom field of the right-eye image are located in another access unit.

The top field of the left-eye image and the bottom field of the left-eye image are an example of the first viewpoint image of the first viewpoint, and the top field of the right-eye image and the bottom field of the right-eye image are an example of the second viewpoint image of the second viewpoint. In the case of coding the top field of the right-eye image as a 2D image, the coding condition is determined so that the top field of the left-eye image and the top field of the right-eye image are coded as identical images. The detailed coding condition setting method is as described in the above embodiments.

Though each of the above embodiments describes the case where the feature value detection unit 121 detects the amount of disparity or the amount of motion in the time axis direction as the image feature value, the feature value detection unit 121 may detect a difference between the first viewpoint image and the second viewpoint image. A larger difference between the first viewpoint image and the second viewpoint image causes a larger degree of viewer fatigue when viewing the first viewpoint image and the second viewpoint image as a 3D image. In detail, the feature value detection unit 121 may detect a difference in luminance, a displacement in a vertical direction, or a displacement in a rotation direction between the first viewpoint image and the second viewpoint image, as the image feature value.

The feature value detection unit 121 may also detect a quantization parameter applied to at least one of the two images that are paired when the stereoscopic video is displayed in 3D, as the image feature value. That is, the feature value detection unit 121 may detect a quantization parameter applied to at least one of the first viewpoint image and the second viewpoint image.

Here, the coding condition determination unit 122 sets the 2D coding mode, in the case where the quantization parameter is larger than a predetermined threshold. By setting the 2D coding mode based on the quantization parameter in this way, it is possible to ease viewer strain caused by viewing video involving quantization. In detail, in the case where the quantization parameter is larger than the threshold, 3D video is coarse, and so the degree of fatigue of the viewer's eyes when viewing the stereoscopic video as 3D video increases. By coding the stereoscopic video as 2D video in such a case, it is possible to ease viewer strain caused by viewing video involving quantization.

Note that the present invention may be realized not only as the image coding apparatus and the image coding method as described above, but also as a program causing a computer to execute the image coding method according to the embodiments. The present invention may also be realized as a computer-readable recording medium such as a CD-ROM in which the program is recorded, or information, data, or a signal representing the program. The program, the information, the data, and the signal may be distributed via a communication network such as the Internet.

Furthermore, the components that constitute the image coding apparatus may be partly or wholly implemented on one system LSI (Large Scale Integration). The system LSI is an ultra-multifunctional LSI produced by integrating a plurality of components on one chip, and is actually a computer system that includes a microprocessor, a ROM, a RAM, and the like.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The image coding apparatus and the image coding method according to the present invention are useful for applications of coding, broadcasting, and recording video according to H.264 MVC, and can be used for a digital television, a digital video recorder, a digital camera, and the like.

1. An image coding apparatus that codes stereoscopic video, said image coding apparatus comprising:
a control unit configured to set a coding mode to one of a 2D coding mode and a 3D coding mode, the 2D coding mode being a mode of coding the stereoscopic video so that, when the coded stereoscopic video is decoded and displayed in 3D, the stereoscopic video is displayed as 2D video, and the 3D coding mode being a mode of coding the stereoscopic video so that, when the coded stereoscopic video is decoded and displayed in 3D, the stereoscopic video is displayed as 3D video; and
a coding unit configured to, in the case where said control unit switches the coding mode from the 3D coding mode to the 2D coding mode, code the stereoscopic video according to a 3D coding standard when the coding mode is the 3D coding mode, and code the stereoscopic video according to the 3D coding standard using a coding condition when the coding mode is the 2D coding mode, the coding condition being a condition for causing the stereoscopic video to be viewed as the 2D video when displayed.

2. The image coding apparatus according to claim 1,
wherein said control unit is configured to set the coding mode, based on an image feature value relating to viewer fatigue when the coded stereoscopic video is decoded and displayed in 3D.

3. The image coding apparatus according to claim 2,
wherein said control unit includes:
a detection unit configured to detect the image feature value, based on pixel data included in the stereoscopic video; and
a condition determination unit configured to set the coding mode based on the image feature value detected by said detection unit, and determine the coding condition in the case of setting the coding mode to the 2D coding mode.

4. The image coding apparatus according to claim 3,
wherein said detection unit is configured to detect, as the image feature value, a disparity between two images that are paired when the stereoscopic video is displayed in 3D.

5. The image coding apparatus according to claim 3,
wherein said detection unit is configured to detect, as the image feature value, an amount of motion in a time axis direction of at least one of two images that are paired when the stereoscopic video is displayed in 3D.

6. The image coding apparatus according to claim 3,
wherein said detection unit is configured to detect, as the image feature value, a quantization parameter applied to at least one of two images that are paired when the stereoscopic video is displayed in 3D.

7. The image coding apparatus according to claim 3,
wherein said condition determination unit is configured to determine the coding condition that one of two images that are paired when the stereoscopic video is displayed in 3D is replaced with an other one of the two images, and
said coding unit is configured to replace the one of the two images with the other one of the two images according to the coding condition, and code two images resulting from the replacement according to the 3D coding standard.

8. The image coding apparatus according to claim 3,
wherein one of two images that are paired when the stereoscopic video is displayed in 3D includes a first viewpoint image of a first viewpoint, and an other one of the two images includes a second viewpoint image of a second viewpoint different from the first viewpoint, and
said condition determination unit is configured to determine the coding condition so that the first viewpoint image and the second viewpoint image are coded as images closer to be identical to each other in the case of setting the coding mode to the 2D coding mode, than in the case of setting the coding mode to the 3D coding mode.

9. The image coding apparatus according to claim 8,
wherein in the case of setting the coding mode to the 2D coding mode, said condition determination unit is configured to: set the first viewpoint image in a predetermined reference index in a first reference list; and determine the coding condition that a reference image is only the first viewpoint image set in the reference index, a motion vector is 0, and a residual is 0, as a coding condition of a macroblock included in the second viewpoint image.

10. The image coding apparatus according to claim 8,
wherein in the case of setting the coding mode to the 2D coding mode, said condition determination unit is configured to: set the first viewpoint image in a reference index 0 in a first reference list; and, in the case where a picture type of the second viewpoint image is a P picture, determine the coding condition that a coding type is a skip macroblock, as a coding condition of all macroblocks included in the second viewpoint image.

11. The image coding apparatus according to claim 8,
wherein in the case of setting the coding mode to the 2D coding mode, said condition determination unit is configured to: set the first viewpoint image in a reference index 0 in a first reference list; and, in the case where a picture type of the second viewpoint image is a B picture, determine the coding condition that a reference image is only the first viewpoint image set in the reference index 0, a motion vector is 0, and a residual is 0 as a coding condition of a first macroblock, and also determine the coding condition that a coding type is a skip macroblock as a coding condition of a second macroblock, the first macroblock being a macroblock for which neighboring macroblock information is unusable among a plurality of macroblocks included in the second viewpoint image, and the second macroblock being a macroblock other than the first macroblock among the plurality of macroblocks included in the second viewpoint image.

12. The image coding apparatus according to claim 8,
wherein in the case of setting the coding mode to the 2D coding mode, said condition determination unit is configured to: set the first viewpoint image in a reference index 0 in a first reference list and in a reference index 0 in a second reference list; and, in the case where a picture type of the second viewpoint image is a B picture, determine the coding condition that a coding type is a skip macroblock, as a coding condition of all macroblocks included in the second viewpoint image.

13. The image coding apparatus according to claim 8,
wherein in the case of setting the coding mode to the 2D coding mode, said condition determination unit is configured to: set the first viewpoint image in a reference index 0 in a first reference list; and, in the case where a picture type of the second viewpoint image is a B picture, determine the coding condition that a picture type is a P picture and a coding type is a skip macroblock, as a coding condition of all macroblocks included in the second viewpoint image.

14. An image coding method for coding stereoscopic video, said image coding method comprising:
setting a coding mode to one of a 2D coding mode and a 3D coding mode, the 2D coding mode being a mode of coding the stereoscopic video so that, when the coded stereoscopic video is decoded and displayed in 3D, the stereoscopic video is displayed as 2D video, and the 3D coding mode being a mode of coding the stereoscopic video so that, when the coded stereoscopic video is decoded and displayed in 3D, the stereoscopic video is displayed as 3D video; and
coding, in the case of switching the coding mode from the 3D coding mode to the 2D coding mode, the stereoscopic video according to a 3D coding standard when the coding mode is the 3D coding mode, and the stereoscopic video according to the 3D coding standard using a coding condition when the coding mode is the 2D coding mode, the coding condition being a condition for causing the stereoscopic video to be viewed as the 2D video when displayed.

15. A program for coding stereoscopic video, said program causing a computer to execute:
setting a coding mode to one of a 2D coding mode and a 3D coding mode, the 2D coding mode being a mode of coding the stereoscopic video so that, when the coded stereoscopic video is decoded and displayed in 3D, the stereoscopic video is displayed as 2D video, and the 3D coding mode being a mode of coding the stereoscopic video so that, when the coded stereoscopic video is decoded and displayed in 3D, the stereoscopic video is displayed as 3D video; and
coding, in the case of switching the coding mode from the 3D coding mode to the 2D coding mode, the stereoscopic video according to a 3D coding standard when the coding mode is the 3D coding mode, and the stereoscopic video according to the 3D coding standard using a coding condition when the coding mode is the 2D coding mode, the coding condition being a condition for causing the stereoscopic video to be viewed as the 2D video when displayed.

16. An integrated circuit that codes stereoscopic video, said integrated circuit comprising:
a control unit configured to set a coding mode to one of a 2D coding mode and a 3D coding mode, the 2D coding mode being a mode of coding the stereoscopic video so that, when the coded stereoscopic video is decoded and displayed in 3D, the stereoscopic video is displayed as 2D video, and the 3D coding mode being a mode of coding the stereoscopic video so that, when the coded stereoscopic video is decoded and displayed in 3D, the stereoscopic video is displayed as 3D video; and
a coding unit configured to, in the case where said control unit switches the coding mode from the 3D coding mode to the 2D coding mode, code the stereoscopic video according to a 3D coding standard when the coding mode is the 3D coding mode, and code the stereoscopic video according to the 3D coding standard using a coding condition when the coding mode is the 2D coding mode, the coding condition being a condition for causing the stereoscopic video to be viewed as the 2D video when displayed.
